(19) United States
(12) Patent Application Publication
(10) Pub. No.: US 2018/0156177 A1
(43) Pub. Date: Jun. 7, 2018

(54) MONITORING OF A STARTUP PROCEDURE WITH SPEED CONTROL SYSTEM

(71) Applicant: Lucas Automotive GmbH, Koblenz (DE)

(72) Inventors: Michael Bast, Bendorf (DE); Nico Stock, Koblenz (DE); Richard Conlong, Koblenz (DE); Pascal Bremm, Zell/Mosel (DE)

(21) Appl. No.: 15/823,681

(22) Filed: Nov. 28, 2017

(30) Foreign Application Priority Data
Dec. 2, 2016 (DE) 10 2016 014 380.0

(51) Int. Cl. F02N 11/08

(52) U.S. Cl. CPC F02N 11/0822; B60W 2720/106; F02N 2200/0801; F02N 2200/101; B60W 2520/28; B60W 2520/105

(57) ABSTRACT

A monitoring method for use in a motor vehicle is proposed. The motor vehicle comprises a speed control system with stop and go function. The monitoring method comprises starling, upon standstill of the motor vehicle, monitoring of a startup procedure of the motor vehicle. The method further comprises monitoring the startup procedure, during the startup procedure, by comparing an actual movement with a maximum movement profile. The actual movement results from measured movements of the motor vehicle. The maximum movement profile represents predefined movements of the motor vehicle. The method further comprises triggering a signal when a currently measured actual movement profile exceeds the maximum movement profile. A monitoring system, and a system comprising the monitoring system and the speed control system with stop and go function are further described.

### TECHNICAL FIELD

In the following there are described a monitoring method and a monitoring system for use in a motor vehicle, which motor vehicle comprises a speed control system with stop and go function. There is further described a system comprising the monitoring system and the speed control system with stop and go function.

### BACKGROUND

In a speed control system with automatic stop and go, the speed control system requests a torque from the vehicle drive train and release of the brakes from the brake system in order to set the motor vehicle in motion from standstill comfortably and accelerate it steadily. The behaviour of the motor vehicle should be as similar as possible at each new startup so that a driver of the motor vehicle can be prepared for it and the speed control system remains manageable. This is important in particular when the driver has to brake because a vehicle in front stops suddenly or because cyclists or pedestrians cross in front of his motor vehicle. If the motor vehicle moves unexpectedly, for example because the startup procedure is jerky, the driver may have too little time to react. Causes of faults can be, for example, too high a torque request, an incorrect shift in the drive or late and uncomfortable release of the brakes. This can impair the safety requirements of the speed control system with automatic stop and go on startup.

### UNDERLYING PROBLEM

The underlying object is to observe safety requirements in traffic on startup of a motor vehicle with speed control system and automatic stop and go.

### PROPOSED SOLUTION

According to a first aspect, a monitoring method for use in a motor vehicle is provided. The motor vehicle comprises a speed control system with stop and go function. The monitoring method comprises starting, upon standstill of the motor vehicle, monitoring of a startup procedure of the motor vehicle. The method further comprises monitoring the startup procedure, during the startup procedure, by comparing an actual movement with a maximum movement profile. The actual movement results from measured movements of the motor vehicle. The maximum movement profile represents predefined movements of the motor vehicle. The method further comprises triggering a signal when a currently measured actual movement exceeds the maximum movement profile.

This has the advantage that the safety of other road users is increased by the additional monitoring.

The maximum movement profile can be described, as a curve, by a maximum path travelled by the motor vehicle in dependence on time, for example as a path-time diagram. The actual movement can be described, as a curve, by a measured path travelled by the motor vehicle in dependence on time, for example as a path-time diagram. A movement can be understood as being a path travelled over a particular period of time. “Predefined movements” can here be understood as being “maximum permissible” movements, which ensure that the motor vehicle drives smoothly. The maximum movement profile can be so defined that the actual movement exceeds the maximum movement profile as a result of a jerky movement. This means that the currently measured actual movement in this case corresponds to the jerky movement and exceeds the maximum movement profile.

The speed control system can also be in the form of an adaptive cruise control system, which is designed to adapt the speed to a vehicle in front.

The monitoring method can further comprise terminating monitoring upon termination of the startup procedure. The monitoring method can further comprise terminating monitoring after the end of a predetermined time interval beginning at a time of starting.

Monitoring can be carried out independently of a control of the speed control system.

The embodiments discussed above have the advantage that a speed control system with automatic stop and go, which additionally comprises such a monitoring method, can better be managed by the driver of the motor vehicle.

Monitoring of the startup procedure can comprise monitoring of a current vehicle wheel speed of the motor vehicle received independently of the speed control system. The currently measured actual movement of the motor vehicle can be determined from the received current vehicle wheel speed.

The triggered signal can warn a driver. The triggered signal can reduce or deactivate acceleration of the motor vehicle. The triggered signal can deactivate the speed control system. The triggered signal can begin an automatic stopping procedure of the motor vehicle by the speed control system. The triggered signal can begin a semi-automatic stopping procedure of the motor vehicle by the speed control system.

Starting can be triggered by a signal delivered by the speed control system.

According to a second aspect, a computer program for implementing a method according to the first aspect is provided.

According to a third aspect, a storage medium for storing a computer program according to the second aspect is provided.

According to a fourth aspect, a monitoring system for use in a motor vehicle is provided. The motor vehicle comprises a speed control system with stop and go function. The monitoring system is designed, upon standstill of the motor vehicle, to start monitoring of a startup procedure of the motor vehicle. The monitoring system is designed to monitor the startup procedure, during the startup procedure, by comparing an actual movement with a maximum movement profile. The actual movement results from measured movements of the motor vehicle. The maximum movement profile represents predefined movements of the motor vehicle. The monitoring system is designed to trigger a signal when a currently measured actual movement exceeds the maximum movement profile.

According to a fourth aspect, a system is provided. The system comprises a monitoring system and a speed control system with automatic stop and go.

Starting can be based on an activation signal. The activation signal can be transmitted to the monitoring system when the speed control system requests torque. The activation signal can indicate that the motor vehicle is at a standstill. The activation signal can further be based on a current speed measurement which is independent of the speed control system. The activation signal can further be triggered upon starting of the startup procedure. A deactivation signal, for terminating monitoring, can be triggered upon termination of the startup procedure.

Starting, upon standstill of the motor vehicle, can further take place when the motor vehicle changes from a state of standstill to a state of driving. Termination of monitoring, upon termination of the startup procedure, can further take place when the received current vehicle wheel speed remains constant compared with the received temporally preceding vehicle wheel speed. A fixed length of time for monitoring, or between starting and terminating monitoring, can be limited to 2 seconds. The duration of monitoring can be between 1 and 2 seconds during the startup procedure. Standstill can be determined from the current vehicle wheel speed of the motor vehicle received independently of the speed control system. The end of the startup procedure can be determined from the vehicle wheel speed of the motor vehicle received independently of the speed control system.

The above-mentioned forms have the advantage that safety for other road users, in particular cyclists and pedestrians, is increased.

It is clear to the person skilled in the art that the explanations set out herein are/will be implementable using hardware, software or a combination thereof. The software can be associated with programmed microprocessors or a computer generally, an ASIC (application specific integrated circuit) and/or DSPs (digital signal processors). For example, the monitoring system can in part be in the form of a computer, a logic circuit, a processor (for example a microprocessor, a microcontroller (μC) or a vector processor)/core (can be integrated in the processor or used by the processor)/CPU (central processing unit; multiple processor cores are possible), an FPU (floating point unit), an NPU (numeric processing unit), an ALU (arithmetic logical unit), a coprocessor (additional microprocessor to assist a main processor (CPU)), a GPGPU (general purpose computation on graphics processing unit), a parallel computer (for simultaneously carrying out computing operations, inter alia on a plurality of main processors and/or graphics processors) or a DSP. It is additionally clear to the person skilled in the art that, although the details described herein are described in relation to a method, these details can also be implemented in a suitable device unit, a computer processor or a memory connected to a processor, the memory being provided with one or more programs which carry out the method when they are executed by the processor. Methods such as swapping and paging can hereby be used.

Although some of the above-described aspects have been described in relation to the monitoring method, these aspects can also apply to the monitoring system. Likewise, the aspects described above in relation to the monitoring system can correspondingly apply to monitoring methods.

### BRIEF DESCRIPTION OF THE DRAWINGS

Further objectives, features, advantages and possible applications will become apparent from the following description of exemplary embodiments, which are not to be interpreted as being limiting, with reference to the associated drawings. In the drawings, all the features which are described and/or depicted show the subject-matter disclosed herein on their own or in any desired combination, also independently of their grouping in the claims or their references. The dimensions and proportions of the components shown in the figures are not necessarily to scale; they can differ from those shown In embodiments for implementation.

FIG. 1 is a schematic representation of a monitoring method; and

FIG. 2 is a schematic representation of a system having a monitoring system and a speed control system with automatic stop and go.

The method variants described here of the, and their, functional and operational aspects serve merely for better understanding of their structure, functioning and properties; they do not limit the disclosure, for example, to the exemplary embodiments. The figures are partly schematic, important properties and effects in some cases being shown on a significantly enlarged scale in order to clarify the functions, active principles, technical configurations and features. Any mode of functioning, any principle, any technical configuration and any feature that is/are disclosed in the figures or in the text can be combined freely and arbitrarily with all the claims, any feature in the text and in the other figures, other modes of functioning, principles, technical configurations and features which are contained in this disclosure or follow therefrom, so that all conceivable combinations are to be assigned to the described devices. Combinations between all the individual implementations in the text, that is to say in every section of the description, in the claims, and also combinations between different variants in the text, in the claims and in the figures, are also included and can form the subject-matter of further claims. The claims also do not limit the disclosure and thus the possible combinations of all the indicated features with one another. All the disclosed features are explicitly also disclosed herein individually and in combination with all the other features.

### DETAILED DESCRIPTION

In the figures, components which correspond to one another or are functionally similar are provided with the same reference numerals. The monitoring method and the monitoring system will now be described with reference to exemplary embodiments.

In the following, specific details are described, without implying any limitation, in order to give a complete understanding of the present disclosure. It is, however, clear to a person skilled in the art that the present disclosure can be used in other exemplary embodiments which may differ from the details described below.

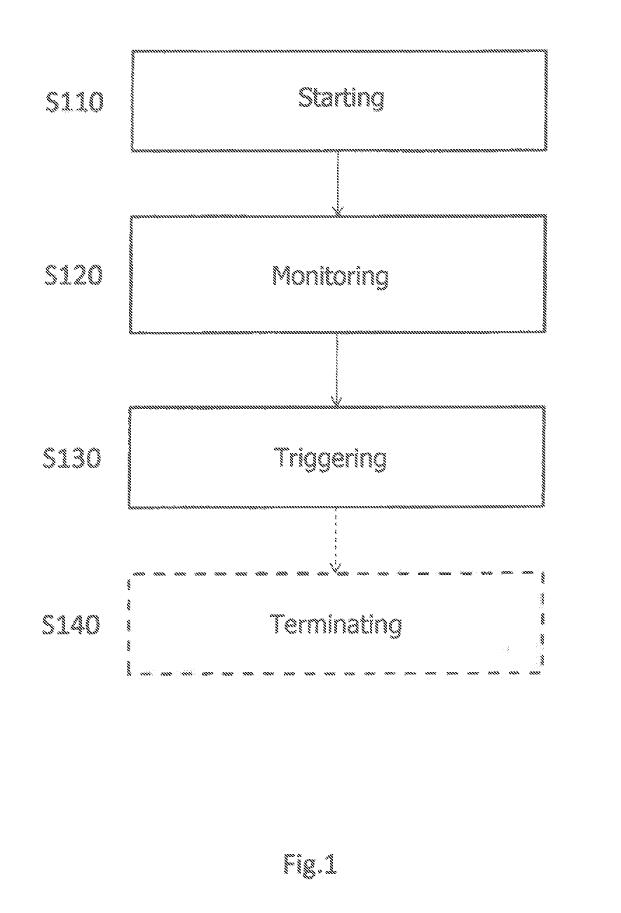

FIG. 1 is a schematic representation of a monitoring method. The monitoring method is provided for use in a motor vehicle. The motor vehicle comprises a speed control system with stop and go function. The speed control system, as an adaptive cruise control system, for example, is designed to adapt a speed to a vehicle in front. The automatic stop and go hereby serves to switch off the engine when the vehicle is at a standstill. The automatic stop and go further serves to start the combustion engine or electric motor when an accelerator pedal is operated by the driver of the motor vehicle.

The monitoring method comprises starting S110, upon standstill of the motor vehicle, monitoring of a startup procedure of the motor vehicle. Possible forms of starting are given as follows. Starting S110 is triggered by a signal delivered by the speed control system. Starting S110 is based on an activation signal. The activation signal is transmitted to the monitoring system when torque is requested by the speed control system. The activation signal indicates that the motor vehicle is at a standstill. The activation signal is further based on a speed measurement that is independent of the speed control system. The activation signal is further triggered when the startup procedure is started. In particular, starting S110 takes place, upon standstill of the motor vehicle, when the motor vehicle changes from a state of standstill to a state of driving.

The monitoring method comprises monitoring S120 the startup procedure, during the startup procedure, by comparing an actual movement with a maximum movement profile. The actual movement results from measured movements of the motor vehicle. The maximum movement profile represents predefined movements of the motor vehicle. In particular, monitoring S120 is carried out independently of a control of the speed control system. Monitoring S120 of the startup procedure comprises monitoring S120 a current vehicle wheel speed of the motor vehicle received Independently of the speed control system. The currently measured actual movement of the motor vehicle is determined from the received current vehicle wheel speed.

The monitoring method comprises triggering S130 a signal when a currently measured actual movement exceeds the maximum movement profile. Execution examples of the monitoring are given in the following. The triggered signal warns a driver in particular of a dangerous situation. The triggered signal reduces or deactivates acceleration of the motor vehicle. The triggered signal deactivates the speed control system. The triggered signal begins an automatic stopping procedure of the motor vehicle by the speed control system. The triggered signal begins a semi-automatic stopping procedure of the motor vehicle by the speed control system.

The monitoring method can further comprise terminating S140 monitoring upon termination of the startup procedure. Terminating S140 monitoring takes place after the end of a predetermined time interval beginning at a time of starting. A deactivation signal, for terminating monitoring, is triggered upon termination of the startup procedure. Furthermore, terminating S140 monitoring, upon termination of the startup procedure, can also take place when the received current vehicle wheel speed remains constant compared with the received temporally preceding vehicle wheel speed. A fixed length of time for monitoring, or between starting S110 and terminating S140 monitoring, is in particular limited to 2 seconds. Standstill is determined in that a current vehicle wheel speed of the motor vehicle received independently of the speed control system provides information relating to the movement state of the motor vehicle. The end of the startup procedure can be determined from the current vehicle wheel speed of the motor vehicle received independently of the speed control system.

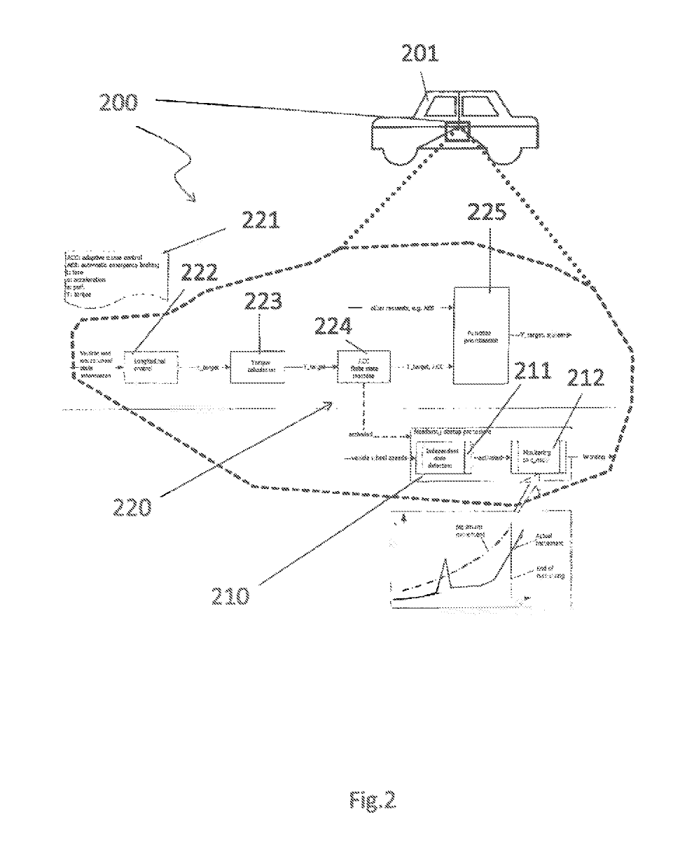

FIG. 2 is a schematic representation of a system 200 having a monitoring system 210 and a speed control system 220 with automatic stop and go. The system 200 comprises the monitoring system 210 and the speed control system 220 with automatic stop and go. The monitoring system 210 is provided for use in a motor vehicle 201. The motor vehicle 201 comprises the speed control system 220 with stop and go function. The monitoring system 210 is designed to start, upon standstill of the motor vehicle 201, monitoring of a startup procedure of the motor vehicle 201. The monitoring system 210 is further designed to monitor the startup procedure, during the startup procedure, by comparing an actual movement with a maximum movement profile. The actual movement results from measured movements of the motor vehicle 201. The maximum movement profile represents predefined movements of the motor vehicle 201.

The monitoring system is further designed to trigger a signal when a currently measured actual movement exceeds the maximum movement profile. Further forms of the system 200, the monitoring system 210 and the speed control system 220 are described in the following.

The speed control system 220 with automatic stop and go is referred to herein as adaptive cruise control, ACC. There are further used in FIG. 2, in block 221, a time t, an acceleration a, a path s and a torque T. The speed control system 220 is divided Into functional blocks 222, 223, 224 and 225. Block 222 represents a longitudinal control 222 of the motor vehicle 201. The longitudinal control 222 receives vehicle state information and environment state information. On the basis of the vehicle state information and the environment state information, a target acceleration is transmitted as output variable a_target to the torque calculation 223. The torque calculation 223 delivers the torque that is to be set to the ACC finite state machine 224. As a result, the ACC finite state machine establishes a state, a variable T_target, ACC delivering the target torque to a function prioritisation 225. The function prioritisation 225 decides, via the variable T_target, ACC and other requests, such as, for example, AEB, which torque T_target, system should actually be requested. The ACC finite state machine 224 of the speed control system 220 delivers a state “activated” to the monitoring system 210 when the monitoring system 210 is to start. Starting is then triggered by the state “activated”. Starting can also be carried out separately, as described In FIG. 1.

The monitoring system 210 is divided into functional blocks 211 and 212. For this purpose, the monitoring system 210 receives a current vehicle wheel speed independently of the speed control system 220 and processes it in order to be able to measure a movement of the vehicle 201. Via the independent state detection 211, a state “activated” can be transmitted to the monitoring 212. The monitoring 212 can compare a maximum movement profile with an actual movement. A signal is then triggered if the actual movement exceeds the maximum movement profile. This means that, when the actual movement exceeds at least a value of the maximum movement profile, a signal, in particular a warning, is triggered. The monitoring system 210 terminates monitoring upon termination of the startup procedure. A predetermined length of time for the termination can also be set, in particular a duration of monitoring from start to end of, for example, 1 to 2 seconds. The maximum movement profile can be defined by a maximum movement, as shown in FIG. 2. Upon termination or upon triggering of the signal, which corresponds, for example, to the request T_target, system, a drive system or a brake system of the motor vehicle 201 is in particular controlled. The request T_target, system can additionally correspond to a warning to the driver, as well as to the triggered signal. The drive system, for example in the case of an electric motor, or the brake system, for example in the case of a combustion engine, then starts and begins the braking procedure. The system 200 can accordingly be equipped with the monitoring system 210 and the speed control system 220 so that it is possible to react as quickly as possible to unexpected situations in the traffic and the motor vehicle 201 is brought to a standstill or slowed down in dangerous situations.

The invention is not limited in any way to the embodiments described above. On the contrary, many possibilities for modifications thereof will be apparent to an average person skilled in the art, without deviating from the underlying idea of the invention as is defined in the claims.

1. Monitoring method for use in a motor vehicle, which motor vehicle comprises a speed control system with stop and go function, the monitoring method comprising:
starting (S110), upon standstill of the motor vehicle, monitoring of a startup procedure of the motor vehicle;
monitoring (S120) the startup procedure, during the startup procedure, by comparing an actual movement with a maximum movement profile, wherein the actual movement results from measured movements of the motor vehicle, and wherein the maximum movement profile represents predefined movements of the motor vehicle; and
triggering (S130) a signal, when a currently measured actual movement exceeds the maximum movement profile.

2. Monitoring method according to claim 1, further comprising:
terminating (S140) monitoring upon termination of the startup procedure or after the end of a predetermined time interval beginning at a time of starting.

3. Monitoring method according to claim 1 wherein monitoring (S120) is carried out independently of a control of the speed control system.

4. Monitoring method according to claim 1, wherein monitoring (S120) of the startup procedure comprises monitoring (S120) a current vehicle wheel speed of the motor vehicle received independently of the speed control system, and wherein the currently measured actual movement of the motor vehicle is determined from the received current vehicle wheel speed.

5. Monitoring method according to claim 1, wherein the triggered signal warns a driver, reduces or deactivates acceleration of the motor vehicle, deactivates the speed control system and/or begins an automatic or semi-automatic stopping procedure of the motor vehicle by the speed control system.

6. Monitoring method according to claim 1, wherein starting (S110) is triggered by a signal delivered by the speed control system.

7. Computer program product comprising programming code sections for carrying out a method according to claim 1 when the computer program product is executed on one or more processing units.

8. Computer program product according to claim 7 which is stored on one or more computer-readable storage media.

9. Monitoring system (210) for use in a motor vehicle, which motor vehicle comprises a speed control system (220) with stop and go function, wherein the monitoring system (210) is designed:
to start, upon standstill of the motor vehicle, monitoring of a startup procedure of the motor vehicle;
to monitor the startup procedure, during the startup procedure, by comparing an actual movement with a maximum movement profile, wherein the actual movement results from measured movements of the motor vehicle, and wherein the maximum movement profile represents predefined movements of the motor vehicle; and
to trigger a signal when a currently measured actual movement exceeds the maximum movement profile.

10. System (200) comprising a monitoring system (210) according to claim 1 and a speed control system (220) with automatic stop and go.
